(19) United States
(12) Patent Application Publication
(10) Pub. No.: US 2025/0112005 A1
(43) Pub. Date: Apr. 3, 2025

(54) TRIGGER SWITCH

(71) Applicant: OMRON Corporation, KYOTO (JP)

(72) Inventors: Isao OZOE, Kyoto-shi (JP); Makito MORII, Kyoto-shi (JP); Koji OMORI, Kyoto-shi (JP); Yasunori YAMANE, Kyoto-shi (JP); Hiroaki YAMANE, Kyoto-shi (JP); Tatsuro KATO, Kyoto-shi (JP)

(73) Assignee: OMRON Corporation, KYOTO (JP)

(21) Appl. No.: 18/811,779

(22) Filed: Aug. 22, 2024

(30) Foreign Application Priority Data
Sep. 28, 2023 (JP) 2023-167620

(51) Int. Cl. H01H 13/08; B25F 5/02

(52) U.S. Cl. CPC H01H 13/08; B25F 5/02; H01H 2231/048

(57) ABSTRACT

A trigger switch includes: a housing, housed in a main unit; a trigger, accepting a push operation with a part located outside the housing, and moving when pushed by the push operation and when the push operation is released; and an energizing member, energizing the trigger in an opposite direction to the push operation, and is capable of being incorporated into the main unit. The energizing member energizes the trigger in an opposite direction to the push operation at one end side located outside the housing, and has other end side fixed inside the housing.

### CROSS-REFERENCE TO RELATED APPLICATION

This application claims the priority benefit of Japan application serial no. 2023-167620, filed on Sep. 28, 2023. The entirety of the above-mentioned patent application is hereby incorporated by reference herein and made a part of this specification.

### BACKGROUND

### Technical Field

The disclosure relates to a trigger switch provided with a trigger that accepts a push operation.

### Description of Related Art

Trigger switches used to operate electric devices such as power tools have a trigger that an operator places his or her finger on and pulls (pushes) the trigger. The operator operates the electric device by a push operation on the trigger. For example, the trigger switch described in Patent Document 1 includes a trigger that moves when a push operation is performed, a movable contact point that moves with the movement of the trigger, a housing that houses the movable contact point, and an energizing member that energizes the trigger in the housing in an opposite direction to the push operation direction using a compression coil spring. As electric devices provided with such trigger switches become more widespread, various improvements to the trigger switches are also being sought. One of the demands for improvement is, for example, miniaturization of trigger switches.

For example, when the housing of a trigger switch is made smaller in size for miniaturization, it becomes necessary to shorten the length of the expansion and contraction direction of the compression coil spring provided as an energizing member within the housing. However, when the compression coil spring is shortened, various problems occur with respect to the operation feeling, such as the inability to obtain a sufficient amount of depression for sensing the push operation and the difficulty in fine-tuning the push operation.

The disclosure has been made in view of the above circumstances and provides a trigger switch that enables the miniaturization of an electric device without impairing the operation feeling.

### SUMMARY

The trigger switch disclosed in the present application includes a housing, housed in a main unit; a trigger, accepting a push operation with a part located outside the housing, and moving when pushed by the push operation and when the push operation is released; and an energizing member, energizing the trigger in an opposite direction to the push operation. The trigger switch is capable of being incorporated into the main unit, and the energizing member energizes the trigger in an opposite direction to the push operation at one end side located outside the housing, and has other end side fixed inside the housing.

### BRIEF DESCRIPTION OF THE DRAWINGS

FIG. 1 is a schematic perspective view illustrating an example of the appearance of the electric device disclosed in the present application.

FIG. 2 is a schematic perspective view illustrating an example of the appearance of the trigger switch disclosed in the present application.

FIG. 3 is a schematic exploded perspective view illustrating an example of the trigger switch disclosed in the present application.

FIG. 4 is a schematic cross-sectional view illustrating an example of the trigger switch disclosed in the present application.

FIG. 5 is a schematic cross-sectional view illustrating an example of the trigger switch disclosed in the present application.

FIG. 6 is a schematic cross-sectional view illustrating an example of the trigger switch disclosed in the present application.

### DESCRIPTION OF THE EMBODIMENTS

Further, in the aforementioned trigger switch, the energizing member is a compression coil spring provided so that an expansion and contraction direction becomes a direction of the push operation and an opposite direction to the push operation.

Further, in the aforementioned trigger switch, the trigger includes a cylindrical part extending in a push operation direction, the housing is formed with an opening through which the cylindrical part is movably inserted, and the energizing member is housed in the cylindrical part.

The trigger switch disclosed in the present application is provided with an energizing member that energizes the trigger at one end side located outside the housing, and has other end side fixed inside the housing.

The embodiments of the disclosure will be described below with reference to the drawings.

### Application Example

The trigger switch disclosed in the present application is applicable to various electric devices including electric tools such as an electric drill, an electric driver, an electric wrench, and an electric grinder, which are provided with a drive unit such as a motor. Hereinafter, an electric device PT and a trigger switch TS attached to the electric device PT, which are illustrated in the drawings, will be described with reference to the drawings.

### Electric Device PT

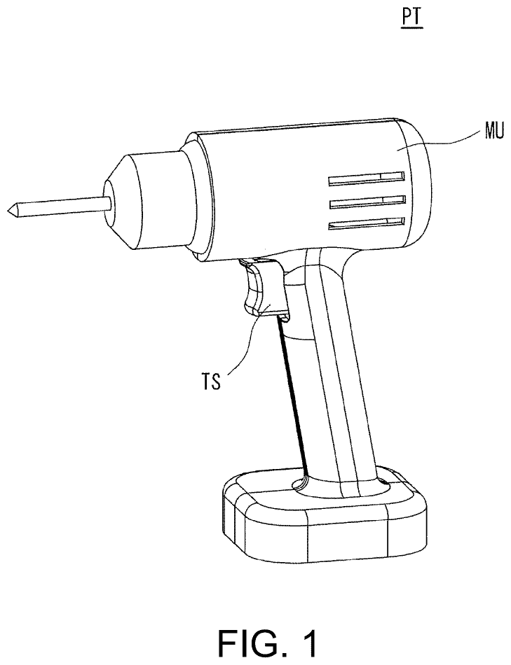

FIG. 1 is a schematic perspective view illustrating an example of the appearance of the electric device PT disclosed in the present application. The electric device PT disclosed in the present application may be applied to various devices such as electric tools, including an electric drill, an electric driver, an electric wrench, and an electric grinder, as well as water guns, paint guns, and model guns provided with a trigger switch TS. The electric device PT illustrated in FIG. 1 includes a main unit MU, and the main unit MU incorporates a trigger switch TS that accepts a push operation from a user. The main unit MU of the electric device PT illustrated in FIG. 1 has a shape in which a handheld portion is attached to a substantially cylindrical main body part that houses a drive unit (not shown) such as an electric motor. The trigger switch TS is incorporated into the handheld portion of the main unit MU. The trigger switch TS disclosed in the present application is suitable for attachment to a main unit MU having a thin handheld portion. An electric device PT having a main unit MU with a thin handheld portion has features such as being easy to hold and easy to operate even for people with small hands. In the following description, as shown in the drawings, the direction of the substantially cylindrical main body portion is referred to as the up direction, and the direction of the handheld portion is referred to as the down direction. Further, the direction in which a rotary tool portion such as a drill is attached is referred to as the front direction, and the direction in which the trigger switch TS is pushed is referred to as the rear direction. That is, in the trigger switch TS incorporated in the electric device PT, the direction from front to rear becomes the operation direction in which the switch is pushed in the push operation. These are directions for convenience of description and do not limit the directions of use of the electric device PT and the trigger switch TS.

### Trigger Switch TS

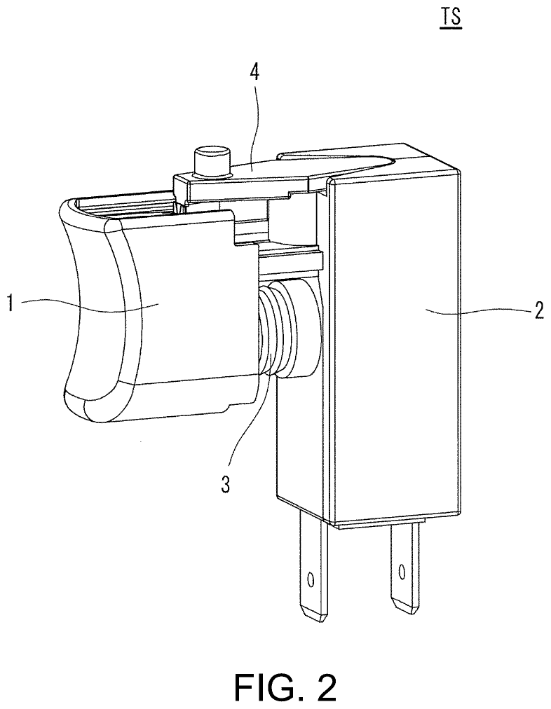

Next, the trigger switch TS provided in the electric device PT will be described. FIG. 2 is a schematic perspective view illustrating an example of the appearance of the trigger switch TS disclosed in the present application. FIG. 1 illustrates the appearance of a trigger switch TS that is capable of being incorporated into a main unit MU, as viewed from diagonally left. The trigger switch TS is a switch operated by an operator of the electric device PT, and includes a trigger 1 with which the operator performs a push operation. When an operator performs a push operation by pushing the trigger 1 of the trigger switch TS, a drive unit (not shown) such as an electric motor incorporated into the main unit MU is driven. In addition to the trigger 1, the trigger switch TS includes various components such as a housing 2 housed in the main unit MU, a covering member 3 that covers a connecting portion between the trigger 1 and the housing 2, and a switching mechanism 4 attached to an upper part of the housing 2.

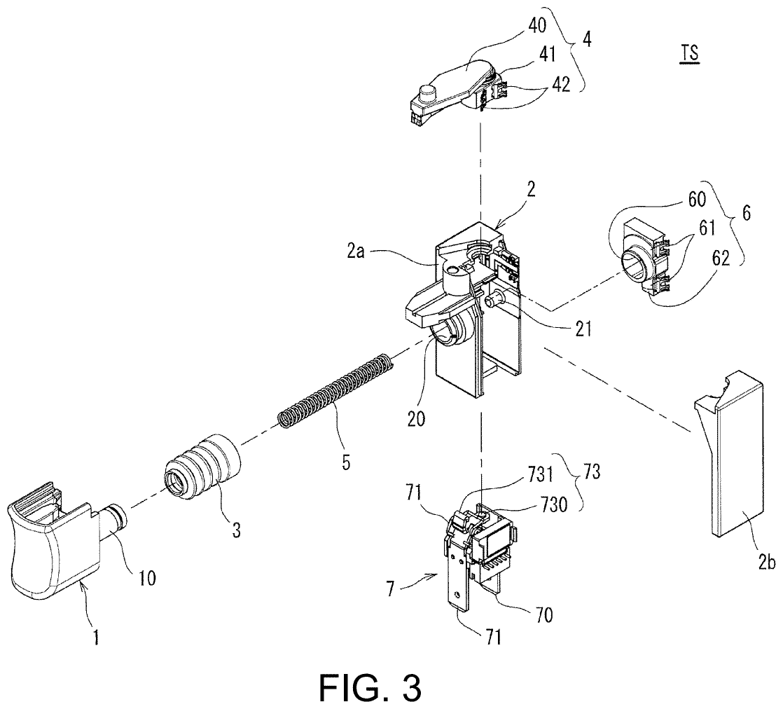

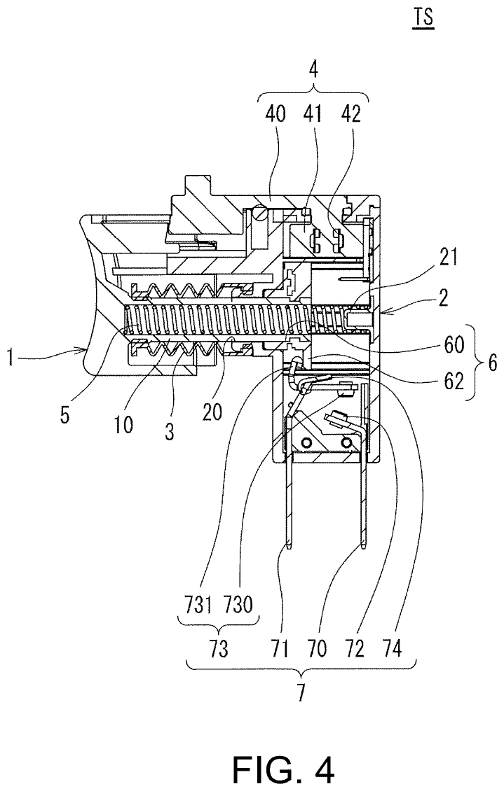

FIG. 3 is a schematic exploded perspective view illustrating an example of the trigger switch TS disclosed in the present application. FIG. 4 is a schematic cross-sectional view illustrating an example of the trigger switch TS disclosed in the present application. The trigger switch TS includes various components such as the trigger 1, the housing 2, the covering member 3, and the switching mechanism 4 described above, as well as an energizing member 5, a moving member 6, and an opening/closing mechanism 7.

The trigger 1 is a member that accepts a push operation from an operator. The trigger 1 has a shape of a substantially rectangular parallelepiped, and is formed in a box shape having an internal space, with the rear surface being open. The front part of the trigger 1 is located outside the housing 2 so as to be operable by a user, and the front surface of the trigger 1 is concavely curved so that the user may easily place his/her finger thereon when operating. The trigger 1 has a cylindrical part 10 extending rearward from an inner wall surface at the front part (push direction), and the cylindrical part 10 serves as a connecting portion between the trigger 1 and the housing 2. The cylindrical part 10 has a long, generally cylindrical shape and is formed on the trigger 1 so as to have the axial direction as the front and rear direction. The cylindrical part 10 has a bottom surface portion on the front end side, which is closed by the inner wall surface at the front part of the trigger 1. The cylindrical part 10 has an opened bottom surface on the rear end side, and the moving member 6 is externally fitted and attached to the rear end portion. An energizing member 5 is housed inside the cylindrical part 10, and a front end (one end) of the energizing member 5 abuts against the inner wall surface at the front part of the trigger 1. The outer surface of the cylindrical part 10 is covered by the covering member 3.

The housing 2 is a hollow case having a substantially rectangular parallelepiped shape, and as illustrated in FIG. 3, may be separated into a right half body 2a and a left half body 2b. On the inner side surface of the left half body 2b of the housing 2, a substrate and an electronic circuit (not shown) using various electronic elements are provided. The housing 2 has a substantially circular insertion hole 20 formed in a wall surface at the front part thereof, and the rear part of the cylindrical part 10 of the trigger 1 is movably inserted into the insertion hole 20. The periphery of the insertion hole 20 opened in the housing 2 has a cylindrical shape that protrudes forward. The covering member 3 is externally fitted onto the portion protruding on the periphery of the insertion hole 20 opened in the housing 2. The housing 2 has a support protrusion 21 of a generally columnar shape formed on the inner wall surface at the rear part thereof, and the support protrusion 21 supports the rear end side (other end side) of the energizing member 5. The switching mechanism 4 is attached to the upper part of the housing 2 so as to penetrate the upper surface. The opening/closing mechanism 7 is attached to the lower part of the housing 2 so as to penetrate the lower surface.

The covering member 3 is made of a flexible material such as rubber or elastic plastic. The covering member 3 is formed in a substantially cylindrical bellows shape with wavy sides, and is expandable and contractible in the axial direction. The covering member 3 is provided so as to cover the cylindrical part 10 of the trigger 1, with the front end fixed at the base portion of the cylindrical part 10 and the rear end fixed so as to be externally fitted around the periphery of the insertion hole 20 opened in the front surface of the housing 2.

The switching mechanism 4 includes a switching lever 40 protruding from the upper surface of the housing 2 to the outside, a switching contact point part 41 housed in the upper part of the housing 2, etc. The switching lever 40 is a member that accepts a switching operation from an operator, and swings left and right in response to the operator's operation. The switching operation by the operator is, for example, an operation to switch the operating mode of the drive unit, specifically, an operation for switching between forward rotation and reverse rotation of the drive unit, switching between constant speed mode and variable speed mode of the drive unit, etc. The switching lever 40 swings left and right in response to the switching operation performed by the operator and transmits the swinging motion to the switching contact point part 41. Furthermore, when the switching lever 40 is operated to be located in the middle of the swing range, the switching lever 40 functions as a stopper that prevents a push operation on the trigger 1. The switching contact point part 41 includes brush-like first sliding contact points 42 on the left side thereof which forms a switching circuit together with an electronic circuit provided on the inner side surface of the left half body 2b of the housing 2. The switching contact point part 41 moves back and forth within the housing 2 by the swinging motion of the switching lever 40. The switching contact point part 41 switches the switching circuit by moving back and forth, thereby switching the operation mode of the drive unit.

The energizing member 5 is formed, for example, using a compression coil spring that expands and contracts in the longitudinal direction. The energizing member 5 is housed in the cylindrical part 10 of the trigger 1. The front end side (one end side) of the energizing member 5 is located outside the housing 2 and abuts against the inner wall surface at the front part of the trigger 1 with the front end thereof, energizing the trigger 1 forward, which is the opposite direction to the push operation. The rear end side (other end side) of the energizing member 5 is located within the housing 2, and is fixed to and supported by the support protrusion 21 formed on the inner wall surface at the rear part of the housing 2. The energizing member 5 configured in this manner has an expansion and contraction direction that is the direction of the push operation and the opposite direction to the push operation. When the trigger 1 is moved rearward by the pressure caused by the push operation, the energizing member 5 is contracted. When the trigger 1 is released from the pressure caused by the push operation and moves forward, the energizing member 5 is expanded. Moreover, in the case where the trigger 1 is located in the front, the rear end portion of the expanded energizing member 5 is exposed from the cylindrical part 10. In this way, in the trigger switch TS disclosed in the present application, one end side of the energizing member 5 energizes the front part of the trigger 1 forward outside the housing 2, and other end side of the energizing member 5 is fixed to the rear part of the housing 2 within the housing 2. Thus, the trigger switch TS disclosed in the present application may ensure a sufficient length of the expansion and contraction direction of the energizing member 5.

The moving member 6 is externally fitted onto the rear end portion of the cylindrical part 10 of the trigger 1 and moves with the movement of the trigger 1, thereby opening and closing an electronic circuit. The moving member 6 is formed in a substantially rectangular parallelepiped shape and has a fitting hole 60 penetrating therethrough from front to rear. The moving member 6 is externally fitted onto the cylindrical part 10 of the trigger 1 via the fitting hole 60. The moving member 6 includes a brush-like second sliding contact point 61 on the left side surface thereof which forms a drive circuit together with an electronic circuit provided on the inner side surface of the left half body 2b of the housing 2. The moving member 6 has a plate-shaped engagement piece 62 expanding downward on the lower surface thereof. The engagement piece 62 of the moving member 6 engages with the opening/closing mechanism 7. The moving member 6 moves back and forth within the housing 2 with the movement of the trigger 1, and the movement of the moving member 6 acts on the drive circuit to start/stop the drive unit or change the drive speed. Further, the moving member 6 engages with the opening/closing mechanism 7 through the movement thereof, and opens and closes the opening/closing circuit formed by the opening/closing mechanism 7.

The opening/closing mechanism 7 has a first terminal 70 and a second terminal 71 exposed to the outside of the housing 2, and is a mechanism for opening and closing a circuit formed between the first terminal 70 and the second terminal 71. When the trigger switch TS is incorporated into the main unit MU, the first terminal 70 and the second terminal 71 of the opening/closing mechanism 7 are electrically connected to a circuit within the main unit MU. When the first terminal 70 and the second terminal 71 of the opening/closing mechanism 7 are electrically connected to a circuit in the main unit MU, the opening/closing mechanism 7 functions, for example, as a switching circuit that electrically connects and disconnects the circuit in the main unit MU and an electronic circuit provided in the housing 2. In addition to the first terminal 70 and the second terminal 71, the opening/closing mechanism 7 includes various other members such as a fixed contact point 72, a swinging member 73, and a spring member 74. The first terminal 70 is a conductive metal piece that penetrates the housing 2 from the inside to the outside, and is formed in a substantially rectangular shape. The first terminal 70 has a bent portion located inside the housing 2, and the fixed contact point 2 is attached to the bent portion. The first terminal 70 and the fixed contact point 72 are electrically connected. The second terminal 71 is a conductive metal piece that penetrates the housing 2 from the inside to the outside, and is formed in a substantially rectangular shape. The second terminal 71 has a bent portion located inside the housing 2, and a swinging member 73 is pivotally supported in the bent portion so as to be swingable. The swinging member 73 is a member bent into a substantially L-shape, which is pivotally supported by the second terminal 71 in the vicinity of the bent portion and swings around the pivotally supported portion as the swing center. The swinging member 73 bent in a substantially L-shape has a swinging contact point 730 attached to one end side and an engaging arm part 731 at other end side. The second terminal 71 and the swinging contact point 730 are electrically connected. The engaging arm part 731 of the swinging member 73 abuts against the engagement piece 62 of the moving member 6 and engages with the engagement piece 62. The swinging member 73 swings about a pivotally supported swing shaft as the swing center, whereby the swinging contact point 730 abuts against/separates from the fixed contact point 72. The spring member 74 is formed using a spring, such as a torsion spring, which winds around the swing shaft about which the swinging member 73 swings, energizing the swinging member 73 to swing in a direction in which the swinging member 73 abuts against a fixed contact point 72. When the swinging contact point 730 abuts against the fixed contact point 72, the circuit between the first terminal 70 and the second terminal 71 is closed, and when the swinging contact point 730 separates from the fixed contact point 72, the circuit between the first terminal 70 and the second terminal 71 is opened.

### Operation of Trigger Switch TS

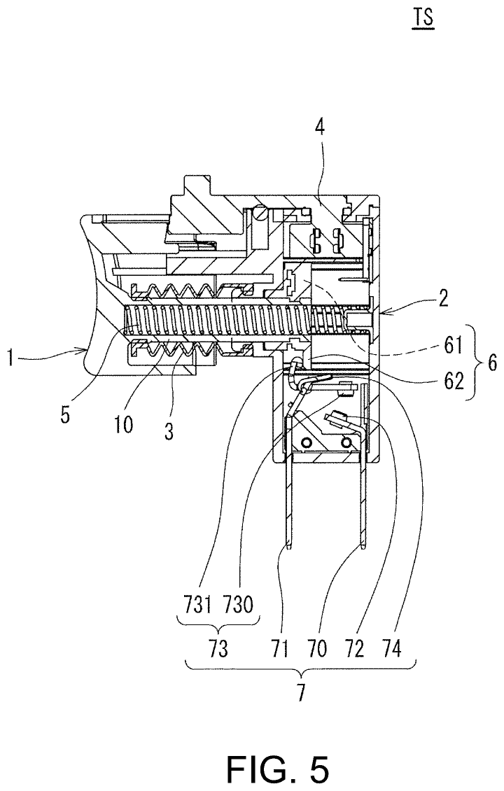

Next, the operation of the trigger switch TS will be described. FIG. 5 is a schematic cross-sectional view illustrating an example of the trigger switch TS disclosed in the present application. FIG. 5 illustrates a released state where the trigger 1 is not pushed. In a released state where the trigger 1 is not pushed, the trigger 1 is located at the front end of the front and rear moving range. The energizing member 5 is at the maximum expansion within the expansion and contraction range. The moving member 6 attached to the trigger 1 is located at the front end of the front and rear moving range, and the engagement piece 62 is engaged with the engaging arm part 731 of the swinging member 73 of the opening/closing mechanism 7. In the opening/closing mechanism 7, the engaging arm part 731 of the swinging member 73 is engaged with the engagement piece 62 of the moving member 6, so that the swinging contact point 730 is separated from the fixed contact point 72 against the energizing force of the spring member 74. In the released state illustrated in FIG. 5, the opening/closing mechanism 7, in which a circuit is formed at the second sliding contact point 61 (in FIG. 5, the corresponding position is indicated by a dotted line) of the moving member 6, is in a state in which the drive unit is stopped. Further, since the swinging contact point 730 and the fixed contact point 72 are separated from each other, the circuit between the first terminal 70 and the second terminal 71 of the opening/closing mechanism 7 is opened.

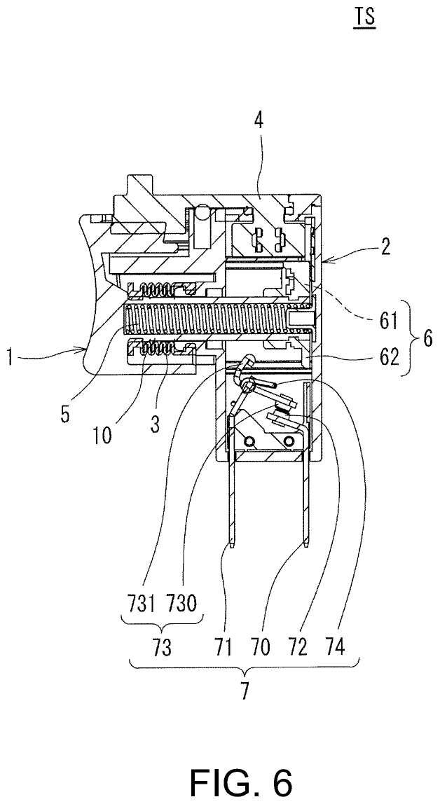

FIG. 6 is a schematic cross-sectional view illustrating an example of the trigger switch TS disclosed in the present application. FIG. 6 shows a pushed state in which the trigger 1 is pushed by a push operation from the state illustrated in FIG. 5. In the pushed state in which the trigger 1 is fully pushed as illustrated in FIG. 6, the trigger 1 is located at the rear end of the front and rear moving range. The energizing member 5 is contracted to the shortest extent within the expansion and contraction range. The moving member 6 is located at the rear end of the front and rear moving range, and the engagement piece 62 is disengaged from the engaging arm part 731 of the swinging member 73 of the opening/closing mechanism 7. In the opening/closing mechanism 7, the engagement between the swing arm portion of the swinging member 73 and the engagement piece 62 of the moving member 6 is released, and thus the swinging contact point 730 abuts against the fixed contact point 72 due to the energizing force of the spring member 74. In the pushed state illustrated in FIG. 6, the opening/closing mechanism 7, in which a circuit is formed at the second sliding contact point 61 of the moving member 6, is in a state in which the drive unit is operating. Further, since the swinging contact point 730 and the fixed contact point 72 are in contact with each other, the circuit between the first terminal 70 and the second terminal 71 of the opening/closing mechanism 7 is closed. In this way, the trigger switch TS disclosed in the present application may ensure a sufficient stroke length in the pushing operation, that is, a sufficient difference in the position of the trigger 1 in the released state and in the pushed state.

As described above, in the trigger switch TS disclosed in the present application, one end side of the energizing member 5 energizes the front part of the trigger 1 forward outside the housing 2, and other end side of the energizing member 5 is fixed to the rear part of the housing 2 within the housing 2. Thus, the trigger switch TS disclosed in the present application may have a short front-to-rear length. As a result, the trigger switch TS disclosed in the present application has excellent effects such as being able to be realized as a small-sized trigger switch TS that may be incorporated into a main unit MU having a short length in the front and rear direction of the handheld portion.

Moreover, the trigger switch TS disclosed in the present application may ensure a sufficient length in the expansion and contraction direction of the energizing member 5, so there is no need to use a short energizing member 5, and there is no loss of operation feeling, providing other excellent advantages.

Furthermore, the trigger switch TS disclosed in the present application may ensure a sufficient stroke length in the pushing operation, and thus has excellent effects such as being able to maintain the operation feeling required for fine adjustment of the push operation even when miniaturized.

The present invention is not limited to the above-described embodiment, but may be embodied in various other forms. Thus, the above-mentioned embodiment is merely illustrative in all respects and should not be interpreted in a limiting manner. The technical range of the present invention is described by the range of claims and is not restricted by the specification. Furthermore, all modifications and variations that fall within the equivalent range of the claims are within the scope of the present invention.

For example, in the aforementioned embodiment, the energizing member 5 is housed in the cylindrical part 10 formed in the trigger 1, but the trigger switch TS disclosed in the present application is not limited thereto. The trigger switch TS disclosed in the present application may be deployed in various forms as long as it may penetrate the inside and outside of the housing 2 and maintain the operation of the energizing member 5. For example, the trigger switch TS disclosed in the present application may be deployed in various forms, such as restricting the operation of the energizing member 5 to an expansion and contraction direction through a shaft center inside the energizing member 5.

In addition, for example, in the aforementioned embodiment, a compression coil spring is used as the energizing member 5, but the trigger switch TS disclosed in the present application is not limited thereto. The trigger switch TS disclosed in the present application may use various energizing members 5 that energizes a trigger 1 at one end side and are fixed within a housing 2 at other end side. For example, the trigger switch TS disclosed in the present application may be deployed in various forms, such as by using various energizing members 5 including a leaf spring, a torsion spring, or the like.

That is, the trigger switch TS disclosed in the present application may be deployed in various forms according to the following supplementary notes.

### (Supplementary Note 1)

A trigger switch, including:
a housing, housed in a main unit; a trigger, accepting a push operation with a part located outside the housing, and moving when pushed by the push operation and when the push operation is released; and an energizing member, energizing the trigger in an opposite direction to the push operation, wherein the trigger switch is capable of being incorporated into the main unit, and
wherein the energizing member energizes the trigger in an opposite direction to the push operation at one end side located outside the housing, and has other end side fixed inside the housing.

### (Supplementary Note 2)

The trigger switch according to Supplementary note 1, wherein
the energizing member is a compression coil spring provided so that an expansion and contraction direction becomes a direction of the push operation and an opposite direction to the push operation.

### (Supplementary Note 3)

The trigger switch according to Supplementary note 1 or 2, wherein
the trigger comprises a cylindrical part extending in a push operation direction,
the housing is formed with an opening through which the cylindrical part is movably inserted, and
the energizing member is housed in the cylindrical part.

What is claimed is:

1. A trigger switch, comprising:
a housing, housed in a main unit; a trigger, accepting a push operation with a part located outside the housing, and moving when pushed by the push operation and when the push operation is released; and an energizing member, energizing the trigger in an opposite direction to the push operation, wherein the trigger switch is capable of being incorporated into the main unit, and
wherein the energizing member energizes the trigger in an opposite direction to the push operation at one end side located outside the housing, and has other end side fixed inside the housing.

2. The trigger switch according to claim 1, wherein
the energizing member is a compression coil spring provided so that an expansion and contraction direction becomes a direction of the push operation and an opposite direction to the push operation.

3. The trigger switch according to claim 1, wherein
the trigger comprises a cylindrical part extending in a push operation direction,
the housing is formed with an opening through which the cylindrical part is movably inserted, and
the energizing member is housed in the cylindrical part.

4. The trigger switch according to claim 2, wherein
the trigger comprises a cylindrical part extending in a push operation direction,
the housing is formed with an opening through which the cylindrical part is movably inserted, and
the energizing member is housed in the cylindrical part.
